(19) United States
(12) Patent Application Publication
(10) Pub. No.: US 2003/0200043 A1
(43) Pub. Date: Oct. 23, 2003

(54) Method for online ranking of test result for an information processing apparatus of an interactive instructional system

(76) Inventors: Say -Yee Wen, Taipei (TW); Shihi-Li Wen, Taipei (TW)

Correspondence Address: BIRCH STEWART KOLASCH & BIRCH, PO BOX 747, FALLS CHURCH, VA, 22040-0747, US

(21) Appl. No.: 10/127,723

(22) Filed: Apr. 23, 2002

(51) Int. Cl. G06F 19/00

(52) U.S. Cl. 702/108

(57) ABSTRACT

A method for performing online test, scoring and raking test result in an interactive instructional system is provided. An online test is proceeded with a teaching portable information-processing device and several learning portable information-processing devices through a network. The test information is transmitted from the teaching apparatus, and the answering information is replied from the learning portable information processing apparatus to the teaching apparatus. The teaching apparatus scores the test results, then transmits the information of sores and rank to the learning apparatus for display. The teaching portable information processing apparatus are personal digital assistants (PDAs), mobile phones or the like.

### BACKGROUND OF THE INVENTION

1. Field of the Invention

The invention generally relates to a method for an information-processing apparatus of an interactive instructional system, and particularly relates to a method for online ranking of test result in an interactive instructional system having a plurality of portable data processing and communication devices.

2. Related Art

Conventional tests for study are performed by teachers who provide test sheets for students, and check and score the answers after collecting the answer sheets. This process costs much time and becomes a burden of the teacher. Following computer developing, computerized answer-checking methods are also used in order to save some efforts of teachers.

Computerized answer-checking methods are performed by computers with image-recognition to the test answers. The students have to answer the test with specific marking methods that comply with the image-recognition requirements of the computer. Therefore, the answer sheets are processed through computer after testing, and the results can be obtained immediately. Therefore, the computerized answer-checking methods are commonly applied to general tests.

However, in common educational environments, teachers still have to spend a lot of time for tests and scorings. There is a demand for teachers to get easier methods for testing and scoring. As portable information and communication devices, such as personal digital assistant (PDA) , are more and more popular, it is desirable to apply the devices for an interactive and real-time test and scoring process.

### SUMMARY OF THE INVENTION

The object of the invention is to provide a method for performing online test, scoring and ranking of instructional achievement tests through information processing apparatus joining in a wireless network.

A method for scoring and ranking of instructional achievement test through information processing apparatus according to the invention applies a plurality of portable electronic data processing and communication devices, which includes an teaching portable data processing/communication device and several learning portable data processing/communication devices. The method includes the following steps. First, establishing a local-area network of teaching and learning data processing and communication devices. Then, inputting a test command by the teaching apparatus and setting the teaching and learning apparatus into test mode. Further, transmitting test information from the teaching apparatus to the learning apparatus, counting for a time period T at the teaching apparatus, and transmitting a time out command from the teaching apparatus to the learning apparatus after the time period T. Then, replying answering information from each learning apparatus to the teaching apparatus when receiving the tome out command. Further, scoring and ranking the test results of each learning apparatus by the teaching apparatus. And finally, transmitting the scores and rank of the learning apparatus from the teaching apparatus to the learning apparatus.

In the aforesaid method. the process of the teaching apparatus includes following steps. Firstly, inputting a test command. Secondly, selecting test information. Thirdly, transmitting test information to the learning apparatus. Fourthly, counting a time period T. Fifthly, transmitting a time-out command to the learning apparatus after the time period T. Sixthly, receiving answering information coming from the learning apparatus. Seventhly, calculating testing score and ranking result of each learning apparatus according to the answering information. Finally, transmitting the scores and rank of test result to the learning apparatus. The time period T is a time interval preset by the teaching apparatus as a time limit for answering the test.

In each learning apparatus, after the process of receiving test information, a step of keying a finish-answering key and transmitting answering information is included. There is also a step of setting the finish-answering key for the learning apparatus.

The aforesaid data processing/communication apparatus can be personal digital assistant (PDA), notebook computers, palm computers or desktop computers.

### BRIEF DESCRIPTION OF THE DRAWINGS

The invention will become more fully understood from the detailed description given hereinbelow. However, this description is for purposes of illustration only, and thus is not limitation of the invention, wherein:

FIG. 1 is a block diagram of an interactive instructional system of the invention that includes a plurality of PDA;

FIG. 2 is a descriptive view of an interactive instructional system of the invention that includes a plurality of PDA joining a local-area network;

FIG. 3 is a main flowchart of a method for scoring and ranking an online test according to the invention;

FIG. 4 is an operational flowchart of a teaching PDA of the invention; and

FIG. 5 is an operational flowchart of a learning PDA of the invention.

### DETAILED DESCRIPTION OF THE INVENTION

The invention provides a method for performing an online test, scoring and ranking the test result in an interactive instructional system. The interactive instructional system applies portable electronic data processing and communication devices, such as PDAs, mobile communication devices, or portable computers. A teaching (teacher) portable data processing device and several learning (student) portable data processing devices join a wireless local-area network (LAN). The local-area network covers a limited space, such as a classroom. The following descriptions are taking PDAs as embodiments. Through the network, the teaching and learning PDAs perform an online instructional achievement test, and score and rank the test result.

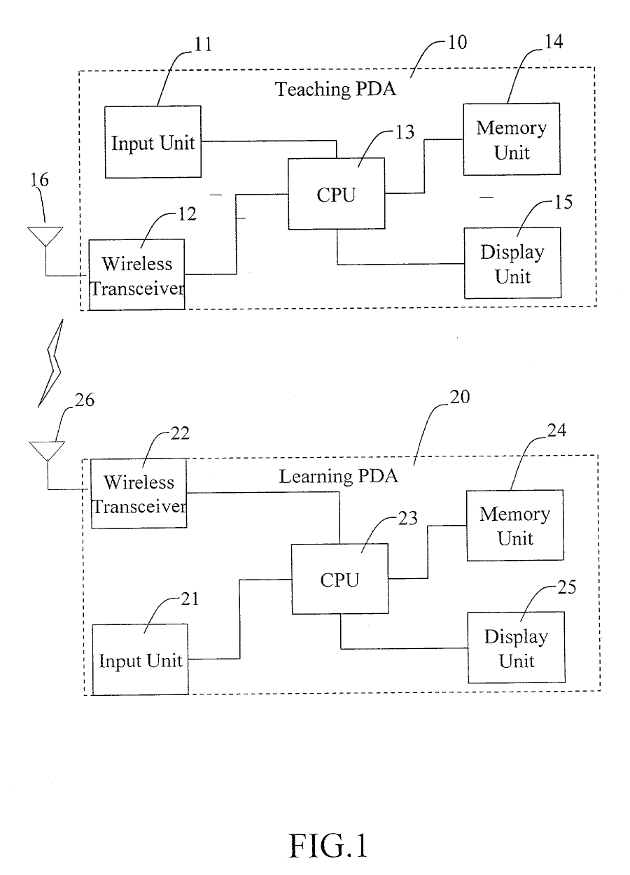

As shown in FIG. 1, an interactive instructional system where the method of the invention applies to includes several PDAs. A teaching PDA 10 and several learning PDAs 20 join a wireless local-area network. The teaching PDA 10 includes an input unit 11, a wireless transceiver 12, a central processing unit 13, a memory unit 14 and a display unit 15. Each of the learning PDAs 20 also includes a wireless transceiver 21, an input unit 22, a central processing unit 23, a memory unit 24 and a display unit 25. The input units 11, 21 are used for inputs of instructional commands and related information. The wireless transceivers 12, 22 are used to transmit and receive information in the local-area network. The memory units 14, 24 store the test information, questions, answers and test results in the teaching PDA 10 or the learning PDA 20. The display units 15, 25 display the related information, including test information and results. The central processing units 13, 23 execute the test commands and perform the scoring and ranking processes.

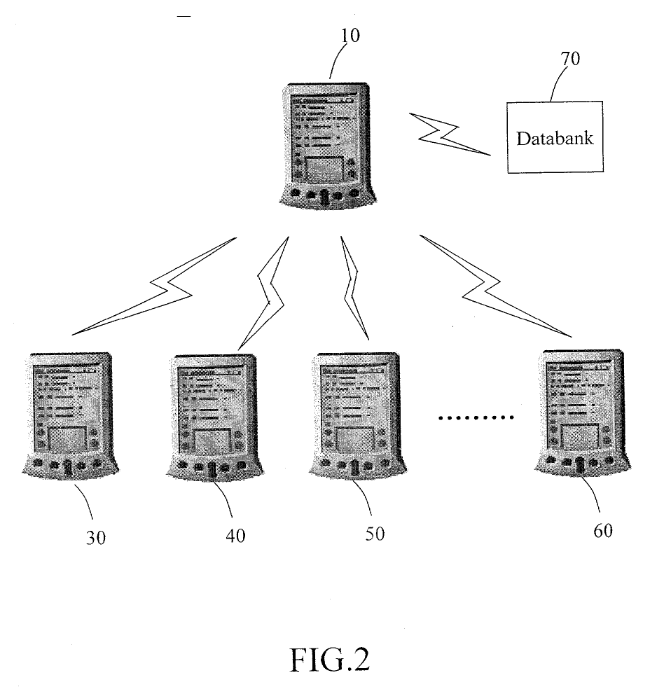

As shown in FIG. 2, an interactive instructional system in which the invention applies includes a plurality of PDAs joining a local-area network. It includes a teaching PDA 10 and several learning PDAs 30, 40, 50, 60 and so on. The PDAs 10 and 30, 40, etc. joint a wireless local-area network so that an online test, scoring and ranking can be achieved. The test information is stored in the teaching PDA 10 or a separated databank 70 and accessible through wireless communication.

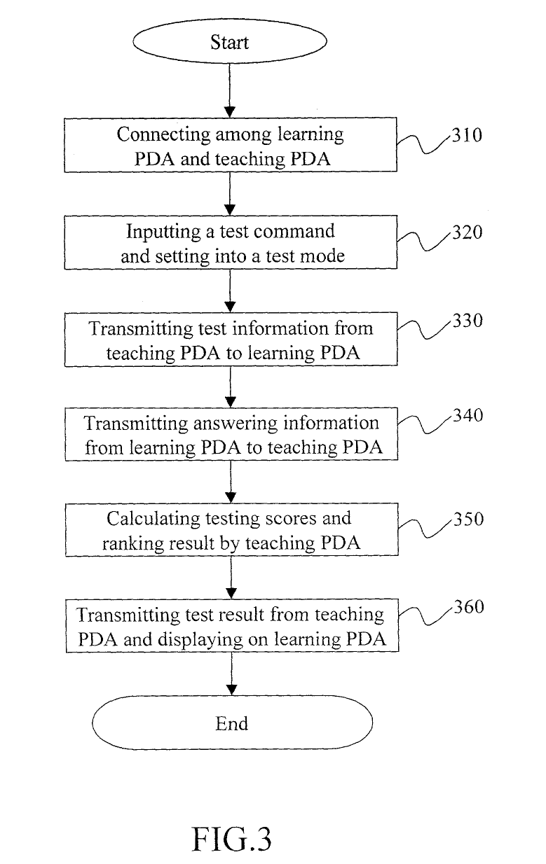

A method for performing an online test, scoring and ranking of test result according to the invention will be described with an embodiment illustrated with FIGS. 3, 4 and 5.

FIG. 3 is a main flowchart of the invention. It includes the following steps. First, connecting among learning PDAs and teaching PDA (step 310). Then, inputting a test command to the teaching PDA for setting the learning and teaching PDAs into a test mode (step 320). The setting is performed by a teacher who operates a TEST key. The TEST key starts a test program stored in the teaching PDA. Correspondent programs are stored in the learning PDAs so as to execute the online test. The programs on the teaching PDA and the learning PDA are not the same, but work together.

A further process is transmitting test information from the teaching PDA to the learning PDAs (step 330). The test information is selected by the teacher from a databank stored in the teaching PDA or other sources. Then, transmitting answering information by the learning PDA to the teaching PDA (step 340). The transmission is done in two manners. The first is by time limit that a time period T for the test is set and counted by the teaching PDA, then a time-out command is transmitted to the learning PDAs for acquiring the answering information. Each learning PDA will transmit the answer information upon receiving the time-out command. The second manner is by active answering of the learning PDA. When the learning finishes answering, a finish-answering key is pressed to transmit the answering information to the teaching PDA. The finish-answering key is preset by the learner. The next process is calculating testing scores and ranking result by teaching PDA (step 350). The scoring and ranking can be expressed with a table or list in a preset format. Finally, transmitting the scores and rank from the teaching PDA to the learning PDAs and displaying on the learning PDAs. (step 360). Therefore, the learners can obtain the test scores and rank in real time.

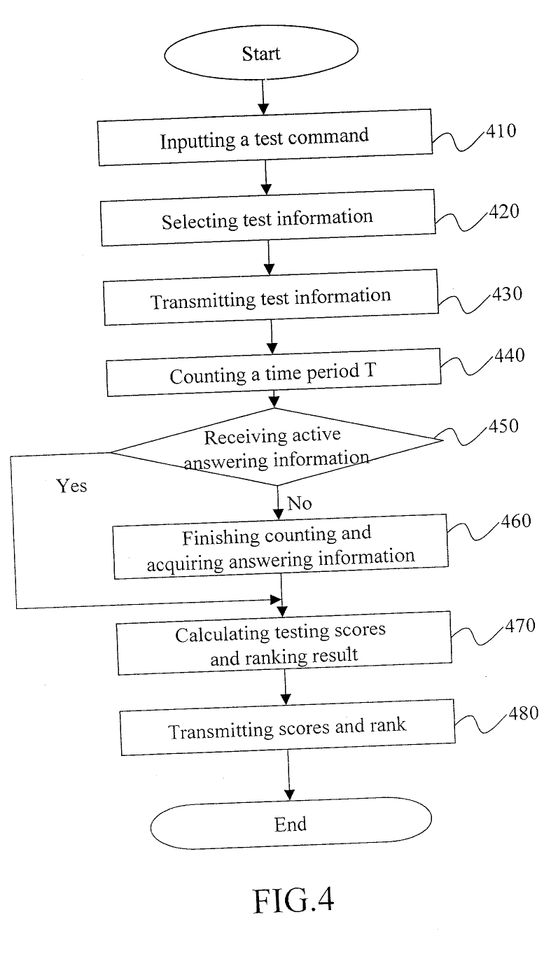

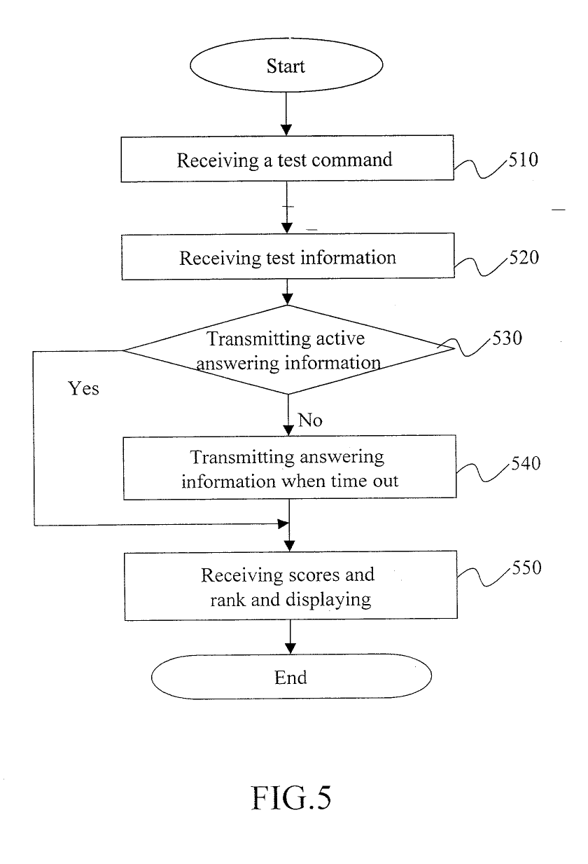

The method of scoring and ranking online test according to the invention is composed of processes at the teaching PDA and the learning PDA. The flowcharts of the processes in the teaching PDA and the learning PDA are illustrated in FIGS. 4 and 5 respectively. In FIG. 4, the operational process in the teaching PDA includes the following steps. First, the teaching PDA inputs a test command after establishing the local-area network (step 410). The test command is inputted by the teacher for starting test programs installed on the teaching PDA and the learning PDA. Then, the teaching PDA selects test information (step 420). The test information is chosen by the teacher, and ascertained by a preset key. Then, the teaching PDA transmits the test information to the learning PDAs (step 430). Meanwhile, it counts a time period T (step 440) which is set by the teacher by consideration of the number or difficulty of the test items. During the time period T, the learner can actively reply with answering information to the teaching PDA. Therefore, the teaching PDA monitors if there is active answering information received during the time period T (step 450). When the time period T reaches, the teaching PDA transmits a time-out command to the learning apparatus to acquire the answering information. Namely, finishing counting and acquiring answering information (step 460). Then, the teaching PDA receives answering information coming from the learning apparatus; calculating testing scores and ranking result (step 470) according to the answering information. Finally, the teaching PDA transmits the scores and rank of test result to the learning apparatus (step 480).

The aforesaid steps finish an online test, scoring and ranking procedure. When a further test is needed, another procedure can be started from beginning of the steps.

In FIG. 5, the operational process in each learning PDA includes the following steps. First, the learning PDA receives the test command and starts a test program after joining the local-area network (step 510). Then, the learning PDA waits to receive test information (step 520). The learner starts to answer the test after receiving the test information. Therefore, the learning PDA waits the learner for transmission of the answering information (step 530). The transmission is ensured by the learner who presses a finish-answering key. The finish-answering key is preset by the learning. Otherwise, the learning PDA transmits the answering information after receiving the time-out command of time period T from the teaching PDA (step 540). Then, the learning PDA waits for receiving the test scores and rank, and displays (step 550) after receiving the test result from the teaching PDA.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for online scoring and ranking of a test utilizing information processing apparatus through a local-area network composed of a teaching information processing apparatus and a plurality of learning information processing apparatus, comprising steps of:
connecting among said teaching and learning apparatus;
inputting a test command by said teaching apparatus for setting said teaching and learning apparatus into a test mode;
transmitting test information from said teaching apparatus to said learning apparatus;
counting for a time period T at said teaching apparatus, and transmitting a time-out command from said teaching apparatus to said learning apparatus after said time period T;
replying answering information from said learning apparatus to said teaching apparatus;
calculating testing scores and a ranking result of said learning apparatus according to said answering information by said teaching apparatus; and
transmitting said testing scores and said ranking result from said teaching apparatus to said learning apparatus.

2. The method of claim 1, wherein said teaching and learning apparatus are selected from the group consisting of personal digital assistants (PDAs), mobile communication devices, and portable computers.

3. The method of claim 1, after said step of transmitting the test information from said teaching apparatus to said learning apparatus, further comprises a step of inputting a finish-answering command from said learning device and transmitting answering information to said teaching apparatus.

4. The method of claim 3, further comprises a step of setting said finish-answering key for said learning device.

5. The method of claim 1, wherein said time period T is a time interval preset by said teaching PDA as a time limit for answering said test.

6. A method for online scoring and ranking of a test utilizing information processing apparatus through a local-area network composed of an teaching information processing apparatus and a plurality of learning information processing apparatus, wherein a process on said teaching apparatus comprising steps of:
inputting a test command;
selecting test information;
transmitting said test information to said learning apparatus;
counting for a time period T, and transmitting a time-out command to said learning apparatus when said time period T reaches;
receiving answering information from said learning apparatus;
calculating testing scores and a ranking result of said learning apparatus; and
transmitting said testing scores and ranking result to said learning apparatus.

7. The method of claim 6. wherein said teaching and learning apparatus are selected from the group consisting of personal digital assistants (PDAs), mobile communication devices, and portable computers.

8. The method of claim 6, after said step of transmitting the test information to said learning apparatus, further comprises a step of receiving answering information from at least a learning device after said learning device executes a finish-answering command by a finish-answering key.

9. The method of claim 8, further comprises a step of setting said finish-answering key for said learning device.

10. The method of claim 6, wherein said time period T is a time interval preset by said teaching apparatus as a time limit for answering said test.

11. A method for online scoring and ranking of a test utilizing information processing apparatus through a local-area network composed of an teaching personal digital assistant (PDA) and a plurality of learning personal digital assistants (PDAs), wherein a process on said teaching personal digital assistant comprising steps of:
inputting a test command;
selecting test information;
transmitting said test information to said learning personal digital assistants (PDAs);
counting for a time period T, and transmitting a time-out command to said learning personal digital assistants (PDAs) after said time period T;
receiving answering information from said learning personal digital assistants (PDAs);
calculating testing scores and a ranking result of said learning personal digital assistants (PDAs); and
transmitting said testing scores and ranking result to said learning personal digital assistants.

12. The method of claim 11, after said step of transmitting the test information to said learning personal digital assistants (PDAs), further comprises a step of receiving answering information from at least a learning personal digital assistant after said learning personal digital assistant executes a finish-answering command by a finish-answering key.

13. The method of claim 12, further comprises a step of setting said finish-answering key for said learning personal digital assistant.

14. The method of claim 11, wherein said time period T is a time interval preset by said teaching personal digital assistant as a time limit for answering said test.
